(19) United States
(12) Patent Application Publication
(10) Pub. No.: US 2018/0191797 A1
(43) Pub. Date: Jul. 5, 2018

(54) DYNAMICALLY GENERATING CUSTOMIZED MEDIA EFFECTS

(71) Applicant: Facebook, Inc., Menlo Park, CA (US)

(72) Inventors: Laura Ling Javier, Burlingame, CA (US); Sachin Monga, San Francisco, CA (US); Kristina Varshavskaya, San Francisco, CA (US); Daniil Burdakov, London (GB); Ittai Sean Barzilay, San Francisco, CA (US); Eric Michael Dorman, San Francisco, CA (US); Huiming Han, San Jose, CA (US); Harshdeep Singh, Santa Clara, CA (US); Matthew Randall Kula, San Francisco, CA (US); Volodymyr Giginiak, London (GB)

(21) Appl. No.: 15/395,883

(22) Filed: Dec. 30, 2016

(51) Int. Cl. H04L 29/06; G06F 17/24; H04L 29/08

(52) U.S. Cl. CPC H04L 65/601; H04L 67/327; H04L 67/2804; G06F 17/24

(57) ABSTRACT

The present disclosure is directed toward systems and methods for generating dynamic media effects ready for sending/posting to allow for in-moment sharing of media communications. One or more embodiments involve dynamically identify contextual information associated with a current environment of a client-computing device (e.g., a mobile phone) associated with a user. The systems and methods utilize the contextual information to generate a customized media effect that the user can share, post, or send to others quickly and easily in order to tell a robust story about an in-moment experience.

### BACKGROUND

Media communication (or communications including images or videos) is an increasingly popular method for users to engage each other. For example, where a user might have in the past composed a text communication share news, the user may now post a digital video/image sharing the news. Media communications have become a preferred means of communication because digital videos, photographs, and the like generally take less time to create than a written message. Similarly, media communications are capable of effectively communicating more than a typical written message.

As media communications have gained popularity, so too have media effects. Media effects are special digital effects that a user applies to a media communication in order to make the communication more interesting, fun, and/or engaging. For example, if a user is creating a digital video to discuss a recent victory of a favorite sporting team, the user may apply a frame including the sporting team's name and colors around the video display. Other media effects can change displayed colors, add text, alter the appearance of people or articles, add additional graphics or animations, and so forth.

Creating media communications with media effects is now so commonplace that there are an ever-increasing number of media effects available to users. This increasing number of media effects, however, is problematic in many ways. For example, the number of media effects that a user generally has to select from is often overwhelming. As such, users typically choose one of only a few previously used media effects, rather than spending the time needed to search through large selections of available media effects.

In order to address the unwieldly nature of large collections of media effects, some conventional systems provide the user with a subset of the collection of media effects. For example, such conventional systems limit the number of media effects available to all users to a predetermined subset that the system periodically rotates. Thus, such conventional systems may provide a first subset of media effects for a week or month and then change the available media effects to a second subset for the next week or month. While providing a universal set of filtered/default media effects to all users/devices helps reduce the problem of searching through a large collection of media effects, it also limits a user's ability to access large numbers of the media effects that may be suitable or desirable for a given communication.

Other conventional systems provide a list of default media effects to all users. If users desire access to additional media effects the users must purchase, download, or unlock the additional media effects. While limiting media effects to a list of default media effects helps reduce the problem of searching through a large collection of media effects, it has other negative drawbacks. In particular, many users often never purchase, download, or unlock the additional media effects due to not knowing this is an option or not having the technical ability, time, or money to access the additional media effects. Thus, the use of a list of default media effects effectively prevents many users from ever accessing or using media effects that may be suitable or desirable for a given communication. Other users may desire and know how to purchase, download, or unlock additional media effects but may again be faced with the difficulty of having to search through large numbers of additional features to find or discover the media effects they wish to make available.

Thus, adding media effects to various types of media communications is typically a time consuming and often frustrating experience. For example, adding a special graphic overlay to a digital photograph generally requires that a user search through lists of tens or even hundreds of graphics. If the user wishes to add additional media effects to the digital photograph, the user must perform additional searches. Accordingly, in order to create a rich and eye-catching media communication, the user must spend several minutes searching for various media effects and applying the media effects to the digital photograph.

As such, users often miss the opportunity to create engaging media communications “in the moment.” Rather, users edit their photographs and videos at a later time, or they skip enhancing their media communications altogether. Accordingly, a need exists for a fast and easy way to add a combination of media effects to digital photographs and videos that make for interesting and engaging media communications.

### SUMMARY

One or more embodiments described herein provide benefits and/or solve one or more of the foregoing or other problems in the art with systems and methods for dynamically providing combinations of media effects to generate media posts that are customized based on a user and their current environment and ready for posting or sending. For example, in one or more embodiments, the systems and methods described herein identify information associated with a current environment of a client-computing device (e.g., a mobile phone) associated with a user as well as information associated with an account of the user of the client-computing device. In at least one embodiment, the systems and methods described herein utilize the information associated with the current environment of the user and the client-computing device to generate a media post including a tailored combination of media effects that is ready for posting by the user. Thus, the systems and methods generate, based on detecting characteristics of a user's current environment and optionally other information associated with the user, a media post that the user can share, post, or send to others quickly and easily.

Additional features and advantages of the present application will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments will be described and explained with additional specificity and detail through the use of the accompanying drawings in which:

FIG. 1 illustrates a detailed schematic diagram of a media effect system in accordance with one or more embodiments;

FIG. 2 illustrates an exemplary environment in which the media effect system can operate in accordance with one or more embodiments;

FIGS. 3A-3F illustrate a series of graphical user interfaces that the media effect system can provide in generating and helping user's share customized media posts in accordance with one or more embodiments illustrating various features of the media effect system;

FIG. 4 illustrates a flowchart of a series of acts in a method of generating a customized media post in accordance with one or more embodiments;

FIG. 5 illustrates a block diagram of an exemplary computing device in accordance with one or more embodiments;

FIG. 6 is an example network environment of a social networking system in accordance with one or more embodiments; and

FIG. 7 illustrates a social graph in accordance with one or more embodiments.

### DETAILED DESCRIPTION

In one or more embodiments, a media effect system generates a media communication tailored to a user and a current environment of the user's client-computing device (e.g., the user's mobile phone). In particular, the media effect system detects current characteristics of the user's client-computing device and optionally analyzes user information. Based on one or more of the detected device characteristics and the analyzed user information, the media effect system generates a customized media communication. In this way, the media effect system generates a media communication that effectively tells a robust story about a user's current environment without requiring the user to provide any input. As such, the media effect system helps a user to communicate in the moment, relevant media communications.

To illustrate the various example features and functionalities of the media effect system, an example embodiment can include a user opening a camera viewfinder on a client-computing device. In response, the media effect system collects and analyzes device characteristics and user information. For example, the media effect system collects device characteristics such as the geographic location of the client-computing device, the direction or orientation of a camera associated with the client-computing device, content in the viewfinder of the client-computing device, and so forth.

Additionally, the media effect system collects user information associated with the user of the client-computing device. For example, in at least one embodiment, the media effect system interfaces with a communications system in order to collect user information such as the user's demographic information, the user's profile information, the user's likes, the user's activity history on the communications system, and so forth. Additionally, the media effect system can collect user information from data stored on the client-computing device such as application usage history, camera usage history, calendar information, contact information, and so forth.

To further illustrate this concept, the media effect system may determine one or more pieces of contextual information from the device characteristics and/or user information. The contextual information can comprise device characteristics and/or user information or be derived from device characteristics and/or user information. For example, the media effect system can determine contextual information such as a location of client-computing device, the orientation of the camera associated with the client-computing device, as well as preferences and activity history associated with the user of the client-computing device. From this information, the media effect system can determine a point of interest corresponding to a geographic location of the client-computing device (e.g., the client-computing device is located at a sports arena or other point of interest), a context or event taking place at the location (that Team A and Team B are currently playing at the sports arena, the weather at the current time at the location), a relationship between the user of the client-computing device that the location, context, or event (e.g., the user is a fan of Team A), image characteristics (e.g., the user is about to take a “selfie” based on the orientation of the camera, object recognition of items in the viewfinder, etc.).

The media effect system then uses the contextual information to generate a customized media communication that tells a robust story about a user's current environment without requiring the user to provide any input. In particular, the media effect system can combine a customized media effect with an image or video to create the customized media communication.

Regarding the customized media effect, in one or more embodiments, the media effect system can identify an overlay template, based on the contextual information, that includes one or more fields to be populated. The media effect system dynamically populates the one or more fields within the overlay template with the contextual information to create a customized media effect (more specifically a customized overlay).

In alternative embodiments, rather than using a template to create the customized media effect, the media effect system can identify a plurality of media effects based on the contextual information. After identifying these compatible media effects, the media effect system generates a customized media effect utilizing a subset of the identified compatible media effects. For example, the media effect system generally identifies more compatible media effects than can be combined into a single customized media effect. Accordingly, in order to determine which media effects to include in the customized media effect, the media effect system can calculate a score for each media effect that reflects how well each media effect corresponds to the contextual information and optionally other media effects. Following this, the media effect system generates the customized media effect by combining one or more high or top-scoring media effects.

The media effect system can then provide the customized media effect in the viewfinder. In response to a capture input, the media effect system can combine the customized overlay with a captured image or video to create the customized media communication. In at least one embodiment, the media effect system provides the customized media effect for preview immediately as soon as the user initiates a communications client application or opens a viewfinder. Thus, the user can quickly preview and utilize the customized media effect frame in combination with a digital photograph or video in order to create a customized media communication that provides robust information about the user and what is taking place in the moment. The user can then send the customized media communication to the communications system for sharing with one or more co-users.

Accordingly, the media effect system saves the user time and energy by providing a customized media effect specifically tailored to the current environment of the user and the user's client-computing device. Additionally, in at least one embodiment, the media effect system is included as part of the functionality of a communications client application, such that the media effect system can apply the customized media effect to an image or video to generate a customized media communication that can be sent with limited user input (e.g., open the client application or a viewfinder and provide a capture input command).

The media effect system saves the user time and energy by providing a customized media effect tailored specifically to the user and the user's client-computing device. Thus, one or more embodiments intelligently and dynamically filter media effects to create an on point customized media effect, thereby reducing the need to search through large numbers media effects. Furthermore, the media effect system provides such benefits while allowing media effects from the entire library of media effects to be included in the set of compatible media effects. Thus, rather than providing a universal set of filtered/default media effects to all users/devices, the media effect system intelligently and dynamically customizes a limited set of featured media effects while providing the flexibility of including any media effect in the set of featured media effects.

Also as used herein, a “media effect” refers to a modification technique applied to an item of digital media (e.g., digital image or video). For example, media effects can include one or more media formats (i.e., types or categories of modification technique) applied to an item of digital media. Examples of media formats include filters, masks, overlays, animations, graphics, frames, and so forth. Thus, a media effect can include one or more instances of media formats (i.e., a particular filter or mask).

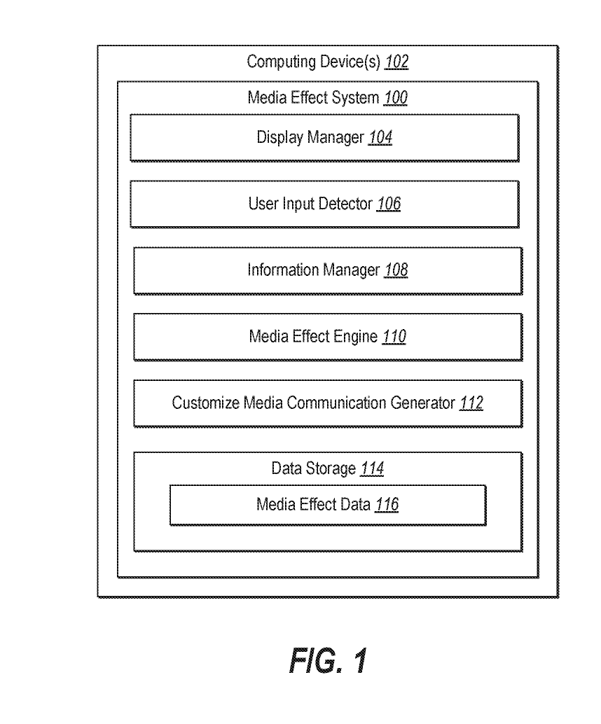

FIG. 1 illustrates a schematic diagram illustrating an example embodiment of the media effect system 100. As shown in FIG. 1, the media effect system 100 implemented by one or more computing devices 102 and includes various components for performing the processes and features described herein. For example, as shown in FIG. 1, the media effect system 100 includes, but is not limited to, a display manager 104, a user input detector 106, an information manager 108, a media effect engine 110, a customized media communication generator 112, and a data storage 114 including media effect data 116. In one or more embodiments, the media effect system 100 is installed on a client-computing device 102. Alternatively, the media effect system 100 is installed on a server device hosting a social networking system. In at least one embodiment, the features and functionality of the media effect system 100 are performed by a combination of one or more client-computing devices and the social networking system.

In one or more embodiments, the media effect system 100 handles activities related to dynamically providing media effects to a user of a client-computing device. For example, the media effect system 100 collects current device characteristics, user information, determines contextual information, identifies media effects, and generates and provides customized media effects whether frames or otherwise. In at least one embodiment, the media effect system 100 includes a repository of media effects (e.g., media effect data 116). Alternatively, in other embodiments, the media effect system 100 may query a remote server or database storing the repository of media effects.

In one or more embodiments, each media effect within the repository utilized by the media effect system 100 is associated with metadata that describes attributes of the media effect. For example, a media effect that causes a cartoon character mask to be displayed over a person's face may be associated with metadata that specifies that the media effect type or format is “mask,” that the media effect is compatible with a “selfie” (e.g., a self-portrait) or a portrait of a single person, that the media effect functions with digital photographs or videos captured by either a front-facing camera or a rear-facing camera, that the media effect is compatible with a wide range of lighting environments, that the media effect is gender-neutral, that the media effect is location-neutral, and so forth. Accordingly, as will be described in greater detail below, the media effect system 100 utilizes this metadata when identifying and ranking each media effect. In at least one embodiment, the creator of a media effect generates the metadata associated with the media effect. Alternatively, in some embodiments, the media effect system 100 analyzes each media effect to generate the metadata associated with each media effect.

As shown in FIG. 1, the media effect system 100 includes the display manager 104. In one or more embodiments, the display manager 104 generates, provides, manages, and/or controls one or more graphical user interfaces that allow a user to interact with features of the media effect system 100. For example, the display manager 104 generates a graphical user interface (“GUI”) that includes a camera viewfinder display along with other selectable controls. In at least one embodiment, the display manager 104 further overlays one or more media effects on the camera viewfinder display in order to provide a preview of how the media effect looks in combination with the camera viewfinder display. The display manager 104 can additionally generate other GUIs that assist a user in creating a multimedia communication and sending the multimedia communication to others.

More specifically, the display manager 104 facilitates the display of a graphical user interface. For example, the display manager 104 may compose the graphical user interface of a plurality of graphical components, objects, and/or elements that allow a user to engage with features of the media effect system 100. More particularly, the display manager 104 may direct a client-computing device to display a group of graphical components, objects, and/or elements that enable a user to interact with various features of the media effect system 100.

In addition, the display manager 104 directs a client-computing device to display one or more graphical objects, controls, or elements that facilitate user input for interacting with various features of the media effect system 100. To illustrate, the display manager 104 provides a graphical user interface that allows a user to edit multimedia. The display manager 104 also facilitates the input of text or other data for the purpose of interacting with one or more features of the media effect system 100. For example, the display manager 104 provides a GUI that that functions in connection with a touch screen. A user can interact with the touch screen using one or more touch gestures to preview media effects, input text, manipulate displays, and so forth.

Furthermore, the display manager 104 is capable of transitioning between two or more GUIs. For example, in one embodiment, the display manager 104 provides a camera viewfinder display. Later, in response to detected input from the user, the display manager 104 transitions to a second GUI that includes a listing of media effects.

As further illustrated in FIG. 1, the media effect system 100 includes the user input detector 106. In one or more embodiments, the user input detector 106 detects, receives, and/or facilitates user input. In some examples, the user input detector 106 detects one or more user interactions with respect to a user interface or GUI. As referred to herein, a “user interaction” means a single interaction, or combination of interactions, received from a user by way of one or more input devices. For example, the user input detector 106 detects a user interaction from a keyboard, mouse, touch page, touch screen, and/or any other input device. In the event the client-computing device includes a touch screen, the user input detector 106 detects one or more touch gestures (e.g., swipe gestures, tap gestures, pinch gestures, reverse pinch gestures) from a user that forms a user interaction. In some examples, a user can provide the touch gestures in relation to and/or directed at one or more graphical objects or graphical elements of a user interface or GUI.

The user input detector 106 may additionally, or alternatively, receive data representative of a user interaction. For example, the user input detector 106 may receive one or more user configurable parameters from a user, one or more commands from the user, and/or other suitable user input. The user input detector 106 may receive input data from one or more components of the media effect system 100 or from one or more remote locations.

The media effect system 100 performs one or more functions in response to the user input detector 106 detecting user input and/or receiving other data. Generally, a user can control, navigate within, and otherwise use the media effect system 100 by providing one or more user inputs that the user input detector 106 can detect.

As illustrated in FIG. 1, the media effect system 100 further includes the information manager 108. In one or more embodiments, the information manager 108 determines current device characteristics associated a client-computing device, identifies user information of a user of the client-computing device, and determines contextual information about the client-computing device and the user of the client-computing device based on the collected user information device characteristics. For example, in at least one embodiment, the information manager 108 collects characteristics associated with a client-computing device including a location of the client-computing device (e.g., based on GPS information, Wi-Fi information, etc.), a date and time associated with the client-computing device, application usage information associated with the client-computing device (e.g., which applications are used on the client-computing device and how often), stored data information (e.g., media files stored on the client-computing device), camera information associated with the client-computing device (e.g., the orientation and configuration of one or more active cameras, lighting conditions detected by one or more active cameras, subject matter associated with one or more active cameras, etc.), account information (e.g., usernames and passwords), and so forth. The information manager 108 collects these characteristics by querying system logs, data storage, etc.

Once the information manager 108 has collected client-computing device characteristics, the information manager 108 can make various determinations in order to determine contextual information for the client-computing device. In at least one embodiment, the contextual information represents the current conditions under which the client-computing device is operating. For example, in one or more embodiments, the information manager 108 can determine contextual information for the client-computing device that includes the current location of the client-computing device, whether the current location is a point-of-interest (e.g., based on an Internet search, social networking system information, etc.), what type of photograph or video the user of the client-computing device is likely taking (e.g., based on active camera orientation, lighting conditions, detected subject matter, etc.), whether the user will likely share the photograph or video to one or more communications systems (e.g., based on application usage data, account information, etc.), and so forth.

Further, in one or more embodiments, the information manager 108 collects user information associated with the user of the client-computing device. For example, in at least one embodiment, the information manager 108 collects user information associated with the user from data stored on the client-computing device (e.g., calendar information, contacts information, application usage information, etc.). Additionally, in one or more embodiment, the information manager 108 also collects user information associated with the user by querying one or more communications systems. For example, in at least one embodiment, the information manager 108 can utilize social networking system account information stored on the client-computing device to query information associated with the user from the social networking system. This social networking system information can include, but is not limited to, profile information, account information, social networking system activity history information (e.g., the user's “likes,” shares, comments, clicks, scrolls, hovers, views, posts, uploads, messages, etc.), and social networking system information associated with one or more co-users (e.g., the user's “friends”).

Once, the information manager 108 has collected user information associated with the user of the client-computing device, the information manager 108 can determine contextual information from the user information. For example, the information manager 108 can determine that the frequency with which the user shares media communications via the social networking system, how often the user adds one or more media effects to the shared media communications, the types of media effects the user prefers, the types of media communications the user shares most often, the people the user is currently with (e.g., by performing facial recognition on people shown in the camera viewfinder), the user's demographics (e.g., age, gender, occupation, etc.), the user's likes and hobbies, the types of social networking system activity the user engages in most often, and so forth.

The information manager 108 can further determine contextual information from one or more third-party content sources. For example, upon determining that the client-computing device is a place of interest, the information manager 108 can query one or more databases or information feeds to determine contextual information about the place of interest for the current time. As instance, the information manager 108 can determine the contextual information that an event is taking place at the place of interest and determine contextual information associated with the event.

In one or more embodiments, the information manager 108 collects device characteristics and user information and determines contextual information utilizing a wide range of techniques. For example, in at least one embodiment, the information manager 108 utilizes one or more of machine learning, computer vision, artificial intelligence, neural networks, Internet queries, and data mining. Accordingly, through the process of information collection and analysis described above, the information manager 108 determines contextual information of the client-computing device and the user of the client-computing device that indicate the conditions under which the client-computing device is operating, as well as the habits and preferences of the user of the client-computing device.

As illustrated in FIG. 1, the media effect system 100 also includes a media effect engine 110. In one or more embodiments, the media effect engine 110 utilizes the contextual information determined by the information manager 108 to generate one or more customized media effects. For example, the media effect engine 110 utilizes the contextual information to identify one or more media effects that are compatible with the current environment of the client-computing device. In at least one embodiment, the media effect engine 110 further narrows the collection of identified media effects based on the contextual information created by the information manager 108.

To illustrate, in at least one embodiment, the media effect engine 110 begins the process of identifying media effects by identifying media effects that are compatible with the current environment of the client-computing device. For example, if the client-computing device profile indicates that only the front-facing camera associated with the client-computing device is activated, the media effect engine 110 will only identify media effects that operate in connection with photographs or videos taken with a front-facing camera. In another example, if the client-computing device determinations indicate that the client-computing device is currently in low-lighting conditions, the media effect engine 110 will only identify media effects that are compatible with low-lighting conditions. In one or more embodiments, the media effect engine 110 identifies media effects that are compatible with the client-computing device by comparing the client-computing device context information to metadata associated with each media effect available to the media effect system 100. In at least one embodiment, the media effect engine 110 utilizes machine learning, neural networks, etc. in identifying compatibilities between the client-computing device profile and the metadata associated with a media effect.

After identifying a collection of media effects that are compatible with the client-computing device, the media effect engine 110 can further narrow the identified collection of media effects based on the contextual information associated the user information. For example, if the contextual information indicates that the user is attending a sporting event (e.g., based on the user's calendar information) and that the user absolutely hates one of the teams participating in the sporting event (e.g., based on the user's social networking system activity history), the media effect engine 110 can narrow the identified collection of media effects such that the collection no longer contains media effects that are favorable to the hated team (e.g., media effects that cheer that particular team). In other words, the media effect engine 110 utilizes the contextual information determined by the information manager 108 to eliminate from consideration those media effects that the user would likely not select.

Additionally, in at least one embodiment, the media effect engine 110 also calculates a score for each media effect in the collection of identified media effects that indicates how well each media effect correlates with the various aspects of the contextual information associated with the client-computing device and the user of the client-computing device. For example, in at least one embodiment, the media effect engine 110 calculates a score for a particular media effect by comparing the metadata associated with that media effect to the determined contextual information. To illustrate, in one embodiment, the contextual information indicates that the user is a female, is currently attending a professional basketball game, is a huge fan of one of the teams playing at the game she is attending, frequently posts “selfies” to the social networking system, prefers media effects that add animated graphics to a digital photograph or video, and has social networking system friends who also frequently post “selfies” to the social networking system. Accordingly, the media effect engine 110 will calculate a higher score for media effects that correlate with these aspects of the user's profile.

In at least one embodiment, the media effect engine 110 increases the score of the media effect in a manner that is directly proportional to the strength of a correlation between a portion of the metadata and the determined contextual information. For example, if metadata associated with a media effect indicates that the media effect is compatible with “selfies,” and the contextual information indicates that the user frequently posts “selfies” to the social networking system, the media effect engine 110 will increase the score for that media effect. If the user's profile indicates that the user only posts “selfies” every once in a while, the media effect engine 110 will only slightly increase the score for that media effect.

In one or more embodiments, the media effect engine 110 may place additional weight on certain correlations between media effect metadata and the contextual information. For example, in one embodiment, the media effect engine 110 places additional weight on correlations that indicate that a media effect is of a certain type that the user frequently applies to digital photographs and videos. To illustrate, if a media effect is associated with a certain sports team (e.g., the media effect adds the team logo to a corner of a digital photograph) and the contextual information indicates the user frequently applies media effects associated with the sports team to digital photographs, the media effect engine 110 will add extra weight to the identified correlation between the media effect type and the contextual information. In one or more embodiments, the media effect engine 110 adds extra weight to correlations associated with the user's history of media effect usage (e.g., the user frequently uses media effects or frequently uses a particular type of media effect), correlations between location-specific media effects and the user's location (e.g., the user located at a sporting event and a media effect is associated with that sporting event), correlations between media effect trends and the user's demographic information (e.g., a particular media effect is very popular among other users who are the same age as the user), and so forth.

In some embodiments, the media effect engine 110 further scores identified media effects based on communications system information. For example, in one or more embodiments, the communications system includes social graph information and one or more affinity scores associated with social networking system objects. Thus, in at least one embodiment, the contextual information can indicate that other social networking system users located at the same event where the user is currently located are frequently posting “selfies.” Accordingly, the media effect engine 110 may increase the score of media effects that are compatible with “selfies” as long as the user is located at that event.

In one or more embodiments, the media effect engine 110 calculates a score for the media effect that reflects how well each media effect correlates one or more aspects of contextual information. In at least one embodiment, the media effect engine 110 performs this same process for each media effect identified, as described above. Alternatively, the media effect engine 110 may only perform the calculation for the first threshold number of identified media effects (e.g., the first 30 media effects, the first 100 media effects, etc.).

The media effects engine 110 uses the scores to generate one or more customized media effects. For example, based on the scores, the media effect engine 110 identifies an overlay template (e.g., the overlay template with the highest score or that otherwise is compatible with the determined contextual information). The overlay template can include one or more fields for entering information. The media effect engine 110 can generate a customized media effect by filling in the one or more fields with determined contextual information as explained in greater detail below.

In alternative embodiments, the media effects engine 110 generates a customized media effect by identifying a threshold amount of top-scoring media effects and then utilizing various rules to combine a subset of those top-scoring media effects into a single a customized media effect. For example, the media effects engine 110 can identify the threshold amount of top-scoring media effects by identifying a threshold percentage (e.g., ten percent) of the media effects in order starting from the media effect with the highest score. In another embodiment, the media effects engine 110 identifies the threshold amount of top-scoring media effects by identifying a threshold number of media effects in order starting from the media effect with the highest score. Regardless of how the media effects engine 110 identifies the collection of top-scoring media effects, the media effects engine 110 is left with one or more media effects that are highly compatible with the contextual information determined or the user and the client-computing device.

Next, the media effects engine 110 applies a series of rules to the collection of top-scoring media effects to identify a subset of the collection that can work in combination. In one or more embodiments, the series of rules help ensure that the media effects are compatible with each other. The media effects engine 110 applies the series of rules as part of an algorithm or pattern. For example, the media effects engine 110 can apply rules such as “only one media effect per region of the digital photograph or video,” “no overlapping media effects,” “no dark text over a dark background,” and so forth. To illustrate, in one example, two of the identified top-scoring media effects overlay text on a top right-hand corner of a digital photograph or video. In light of the rule that only one media effect is allowed per region of the digital photograph or video, the media effects engine 110 will only select one of the two media effects for inclusion in a customized media effect. In at least one embodiment, the media effects engine 110 will select the media effect with the higher score for inclusion in the customized media effect.

In at least one embodiment, in order to effectively identify the subset of media effects that can be part of a customized media effect, the media effects engine 110 also analyzes the underlying digital photograph or video. For example, the media effects engine 110 can utilize computer vision and machine learning in combination with the underlying digital photograph or video to identify regions of color, objects, faces, animals, shadows, and so forth. After making this analysis, the media effects engine 110 can more accurately apply one or more rules, as described above, in selecting media effects to add to a customized media effect. In one or more embodiments, the media effects engine 110 generates the customized media effect from the identified subset of top-scoring media effects and provides the generated customized media effect for preview via one or more GUIs.

In at least one embodiment, the media effects engine 110 can generate textual media effects for inclusion in a customized media effect. For example, in response to contextual information indicating that the user is currently attending a particular event (e.g., a sporting event, a theatrical event, a community event, etc.), the media effects engine 110 can generate a media effect that includes text related to the event (e.g., the current score at the sporting event, a title of a play, etc.). In another example, the media effects engine 110 can utilize facial recognition in combination with social networking system information in order to identify people in a photograph or video. The media effects engine 110 can then generate a textual media effect including the names of the identified people (e.g., “At the game with Charles!”). The media effects engine 110 can then consider this generated media effect along with the other identified media effects in creating the customized media effect. Additionally or alternatively, the media effects engine 110 can present the option to include text related to an identified place or person at a different time, but prior to posting the generated image. For example, the media effect system 100 can generate a customized media effect that does not include any customized text. If the user accepts the customized media effect, the media effect system 100 can accept additional context information via a post composition GUI (e.g., via a user or location tag), as described below, and utilize this additional context information to add customized text to the media effect.

In one or more embodiments, the media effect engine 110 includes various override mechanisms. For example, in one embodiment, the media effect engine 110 may include “hard rules” that are taken into account when selecting media effects for inclusion in a customized media effect (e.g., no media effects with explicit content can be included in a customized media effect). In another embodiment, the media effect engine 110 can include an override setting for promoted content. For example, if an advertiser pays to have a specific media effect promoted to users who meet certain criteria, the media effect engine 110 will include the specific media effect in customized media effects generated for user who meet those criteria. To illustrate, in one example, a soft drink company want to promote itself to users who are attending a particular professional basketball game. Accordingly, the media effect engine 110 will include the soft drink company's logo in all customized media effects generated for users who are attending that particular professional basketball game.

As mentioned previously, in one or more embodiments, the media effect system 100 provides a customized media effect upon a user opening a camera viewfinder or other interface of a communications system application. As such, the media effect system 100 can generate the customized media effect on the fly in real-time so that there is not a delay to generate the customized media effect upon the user selecting to open the camera viewfinder. To enable faster determinations of contextual information, the media effect system 100 queries a social network graph. For example, rather than ingesting a news feed to determine an event at a given location, the media effect system 100 can query a social graph object corresponding to the location to quickly identify an event that is happening at the location.

Similarly, in attempting to identify faces present in an image, video, or live viewfinder stream, the media effect system 100 can query a social graph of a social networking system to identify friends of the user of the client-computing device. Then the media effect system 100 can determine if any faces in the image, video, or live viewfinder stream have a high correspondence with profile pictures of identified friends of the user in the social graph. If there are no profile pictures with high correspondences, the media effect system can search previously tagged faces in a feed or past posts by the user. In this manner, the media effect system 100 can quickly identify events, people to tag, and other contextual information. More detail regarding social graphs and object nodes are provided herein below.

The media effect system 100 further includes a customized media communication generator 112. The customized media communication generator 112 combines a generated customized media effect with a digital image or video to generate a customized media communication.

As illustrated in FIG. 1, the media effect system 100 also includes the data storage 114. The data storage 114 includes media effect data 116. In one or more embodiments, media effect data 116 includes media effect information, such as described herein (e.g., media effect metadata, identified media effect information, customized media effect information, etc.).

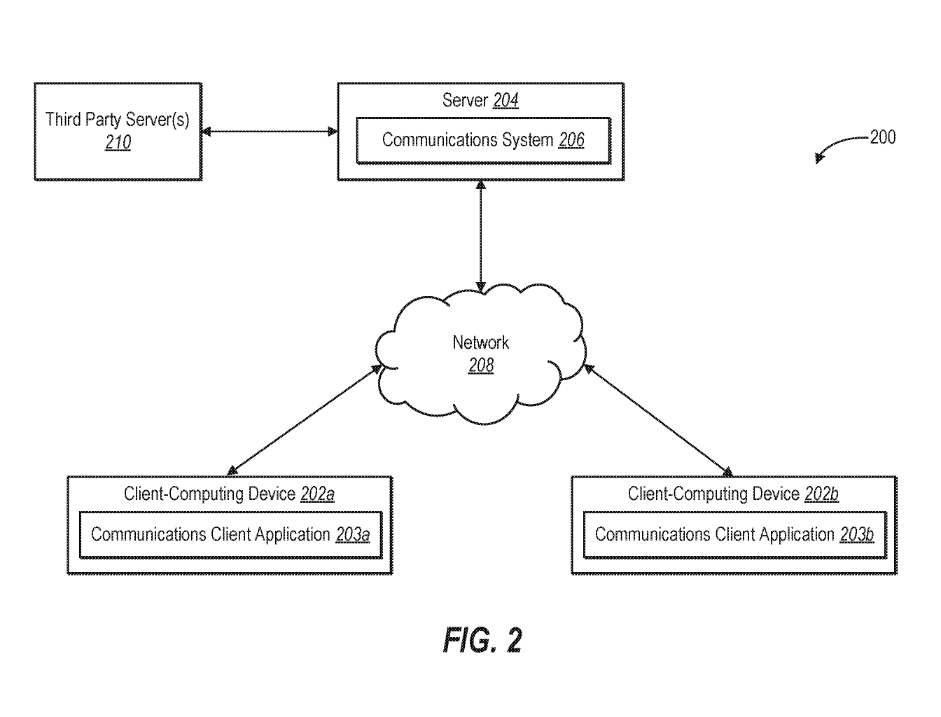

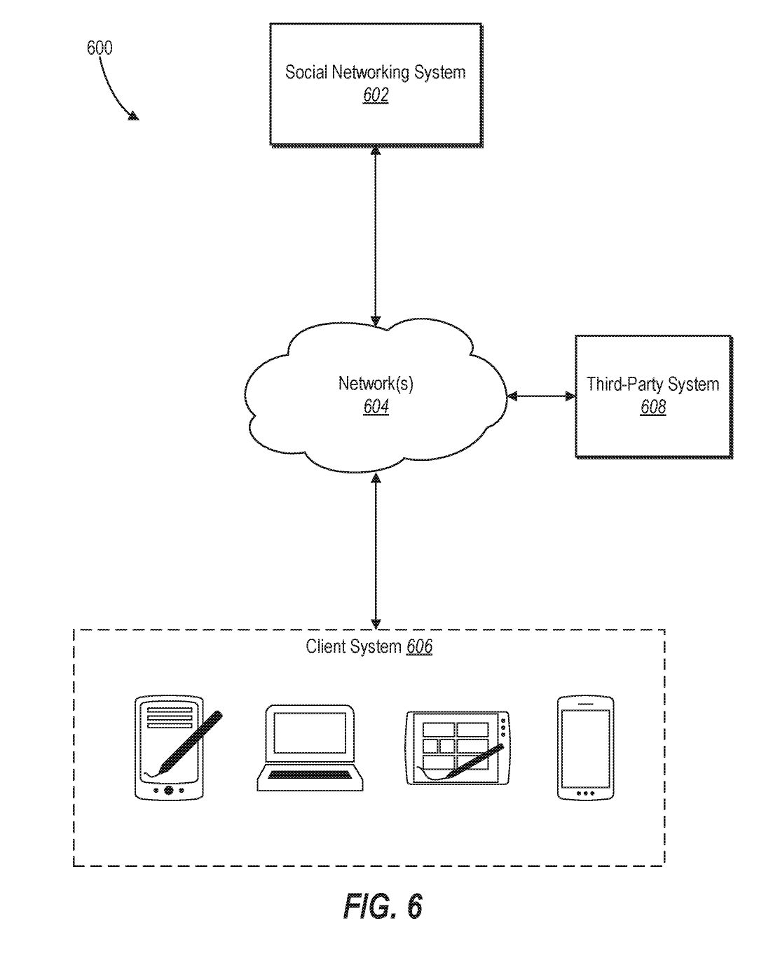

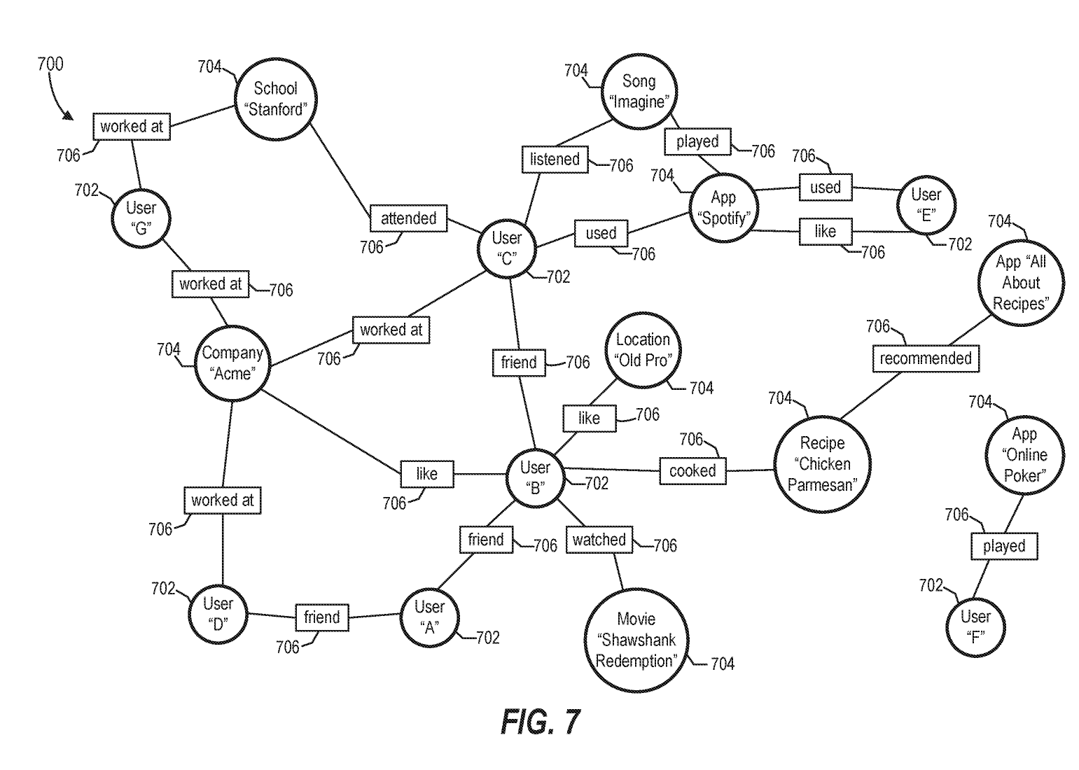

FIG. 2 illustrates an example block diagram of an environment 200 for implementing the media effect system 100. As illustrated in FIG. 2, the environment 200 includes client-computing devices 202a, 202b that implement communications client applications 203a, 203b. Further shown in FIG. 2, the environment 200 also includes a server 204 hosting a communications system 206 (such as a social networking system as described below in relation to FIGS. 6 and 7.

The client-computing devices 202a, 202b and the server 204 communicate via a network 208, which may include one or more networks and may use one or more communication platforms or technologies suitable for transmitting data and/or communication signals. In one or more embodiments, the network 208 includes the Internet or World Wide Web. The network 208, however, can include various other types of networks that use various communication technologies and protocols, such as a corporate intranet, a virtual private network (“VPN”), a local area network (“LAN”), a wireless local network (“WLAN”), a cellular network, a wide area network (“WAN”), a metropolitan area network (“MAN”), or a combination of two or more such networks. Additional details relating to the network 208 are explained below with reference to FIG. 6.

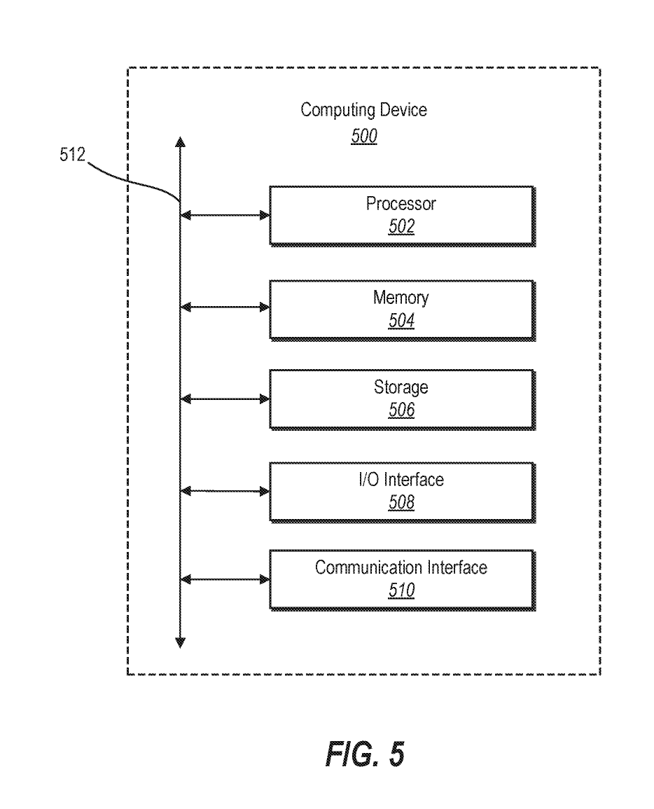

Although FIG. 2 illustrates a particular number and arrangement of client-computing devices, in additional embodiments that client-computing device 202a, 202b may directly communicate with the communications system 206, bypassing the network 208. Further, in other embodiments, the environment 200 may include any number of client-computing devices. Additional details with respect to the computing devices 202a, 202b, 204 (which can comprise examples of the computing device 102) are discussed below with respect to FIG. 5.

In one or more embodiments, the client-computing devices 202a, 202b can be one of various types of computing devices. For example, each of the client-computing devices 202a, 202b may include a mobile device such as a mobile telephone, a smartphone, a PDA, a tablet, or a laptop. Additionally, or alternatively, the client-computing devices 202a, 202b may include a non-mobile device such as a desktop computer, a server, or another type of computing device. It will be understood that a both client-computing devices 202a, 202b can include the same type of computing functionality. In other words, in a preferred embodiment, both the client-computing device 202a and the client-computing device 202b are mobile computing devices, such as smartphones. In at least one embodiment, the user of the client-computing device 202a and the user of the client-computing device 202b are associated (e.g., “friends”) via the communications system 206.

In one or more embodiments, each of the client-computing devices 202a, 202b include a communications client application 203a, 203b associated with the communications system 206. For example, the communications client application 203a, 203b enables the users of the client-computing devices 202a, 202b to view and interact with communications system content, and to submit media communications, posts, and other content to other users via the communications system 206. In at least one embodiment, media communications and other content submitted to the communications system 206 from the client-computing device 202a can be viewed and interacted with at the client-computing device 202b, and vice versa.

As shown in FIG. 2, and as mentioned above, the server 204 hosts the communications system 206. In one or more embodiments, the communications system 206 provides posts, electronic message, structured objects, and live video streams to one or more co-users (e.g., by way of a profile, a newsfeed, a communication thread, a timeline, a “wall,” a live video stream display, or any other type of graphical user interface presented via the communications client application on the client-computing devices 202a, 202b). For example, one or more embodiments provide a user with a social networking system newsfeed containing posts from one or more co-users associated with the user (e.g., the user's “friends”). In one or more embodiments, a post can include one or more media communications (e.g., edited or unedited digital photographs and digital videos), such as described above.

In one or more embodiments, a system user scrolls through his or her social networking system newsfeed in order to view recent social networking system posts submitted by the one or more co-users associated with the user via the communications system 206. In one embodiment, the communications system 206 organizes the social networking system posts chronologically in a user's social networking system newsfeed or wall. In alternative embodiments, the communications system 206 organizes the social networking system posts geographically, by interest groups, according to a relationship coefficient between the user and the co-user, etc. Additionally, in one or more embodiments, the user can download a copy of the social networking system newsfeed as a record of the social networking system posts displayed thereon.

The communications system 206 also enables the user to engage in all other types of communications system activity. For example, the communications system 206 enables a social networking system user to scroll through newsfeeds, click on posts and hyperlinks, compose and submit electronic messages and posts, interact with structured object, watch live video streams, interact with media communications, and so forth.

In one or more embodiments, the media effect system 100, described with reference to FIG. 1, may be implemented by the communications system 206, the server 204, or any of the client-computing devices 202a, 202b. For example, in one embodiment, the communications system 206 includes the media effect system 100. In that embodiment, the communications client applications 203a, 203b enable the client-computing devices 202a, 202b to interface with the media effect system 100 remotely across the network 208. In another embodiment, the communications client applications 203a, 203b both include the media effect system 100. In that embodiments, the communications client applications 203a, 203b may communicate with the communications system 206 and/or the server 204 (or other servers) in order to receive user characteristic information, media effect information, and so forth.

The environment 200 further includes a third-party server 210. The media effect system 100 can obtain event, weather, or other contextual information from the third-party server 210. For example, upon detecting a location of the client-computing device, the media effect system 100 can query a weather server for the current weather at the detected location. As another example, upon detecting a location of the client-computing device, the media effect system 100 can query an information feed for event information related to the detected location at the current time.

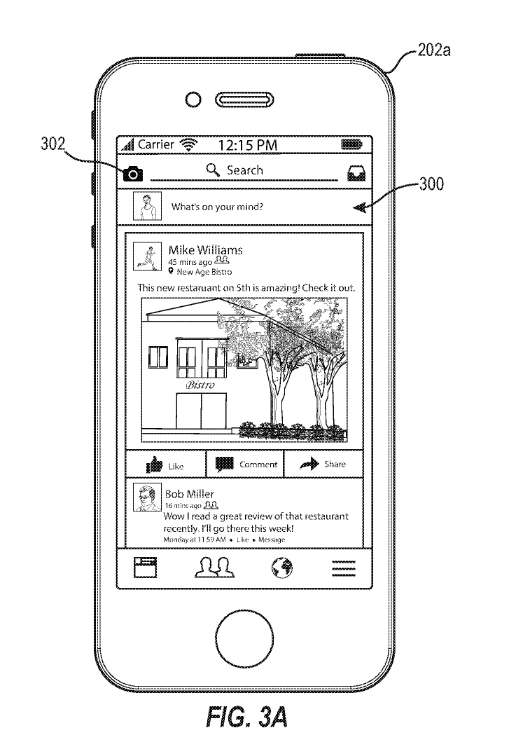

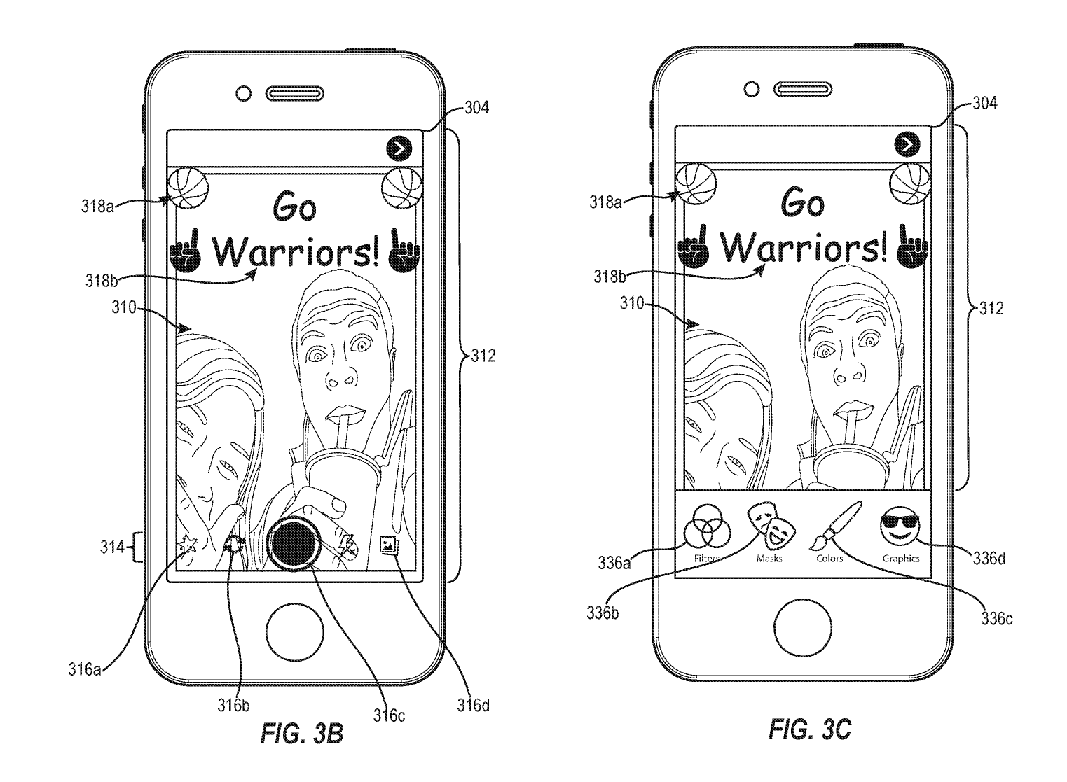

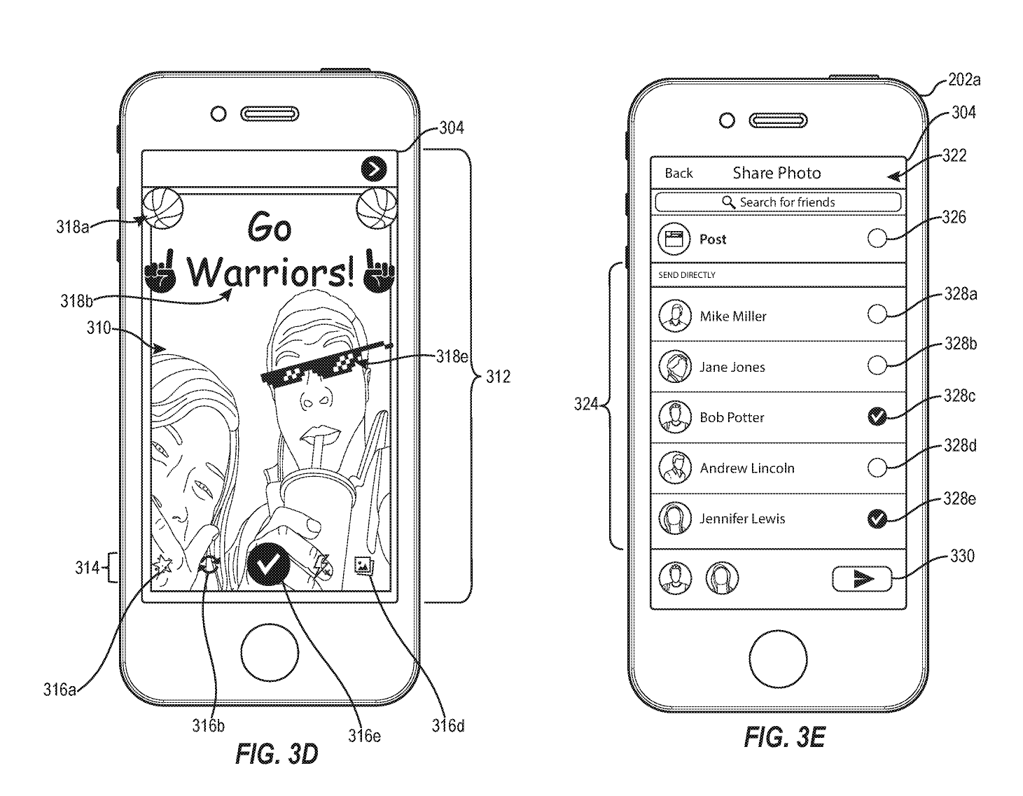

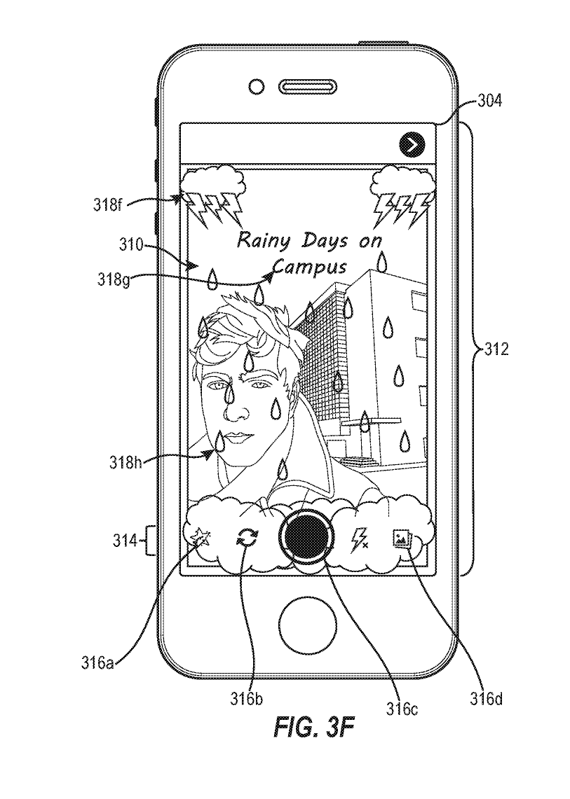

As will be described in more detail below, the components of the media effect system 100 can provide, along and/or in combination with the other components, one or more graphical user interfaces (“GUIs”). In particular, the communications client applications 203a, 203b on the client-computing devices 202a, 202b can display one or more GUIs generated by the media effect system 100, described above. The communications client applications 203a, 203b enable the user of the client-computing device 202a and/or the user of the client-computing device 202b to interact with a collection of display elements within one or more GUIs for a variety of purposes. FIGS. 3A-3F and the description that follows illustrate various example embodiments of the GUIs that are used to describe the various features of the media effect system 100.

For example, as mentioned above, the media effect system 100 provides various features and functionality to the user in response to the user initializing an application in order to create a media communication. FIG. 3A illustrates a user interface 300 of the communications client application 203a provided via the client-computing device 202a. The user interface 300 includes a camera icon 302. Upon selection of the camera icon 302, the media effect system 100 begins the process of generating a customized media effect, as described above. It will be understood that while the media effect system 100 is described herein as performing the determining of the context information and generation of the customized media effect in response to the detected selection of a camera icon 302, in additional embodiments, the media effect system 100 may determine characteristics, identify and rank media effects, etc. at any time as a background process.

In at least one embodiment, instead of acting in response to a selection of the camera icon 302, the media effect system 100 may prompt the user to create a media communication in response to detecting a location of the client-computing device 202a or detecting other contextual information. For example, in response to detecting the client-computing device 202a is located at an event (e.g., a sporting event, a parade, etc.), the media effect system 100 can provide a notification (e.g., a pop-up window, an icon, a text message, an email, etc.) prompting the user to create a media communication related to the location. In response to the user selecting the notification, or a link within the notification, the media effect system 100 can provide a customized media effect, as further described below.

In the illustrative embodiment, in response to a detected selection of the camera icon 302, the media effect system 100 collects and analyzes device characteristics associated with the client-computing device 202a (e.g., camera orientation, GPS location, time and date, application usage history, etc.) and user information associated with the user of the client-computing device 202a (e.g., demographic information, social networking system activity information, social networking system activity information of co-users, etc.). Next, the media effect system 100 determines contextual information by, for example, querying nodes of a social graph or obtaining information from a third-party server 210. Finally, the media effect system 100 dynamically generates a customized media effect that is tailored to the client-computing device 202a and the user of the client-computing device 202a, as described above with reference to FIG. 1.

Thus, immediately upon opening the application associated with the camera icon 302, the media effect system 100 presents a generated customized media effect overlaid on a camera viewfinder display. For example, as shown in FIG. 3B, the media effect system 100 immediately presents a customized media effect overlaid on a media communication GUI 310 on the touch screen display 304 of the client-computing device 202a. In one or more embodiments, the media communication GUI 310 includes a camera viewfinder display 312 and a toolbar 314 with various controls 316a, 316b, 316c, and 316d.

As shown in FIG. 3B, as soon as the application presents the camera viewfinder display 312, the media effect system 100 automatically overlays a customized media effect including the media effect elements 318a and 318b on the camera viewfinder display 312. In one or more embodiments, the camera viewfinder display 312 includes a display of what a camera associated with the client-computing device 202a is currently viewing. Thus, as illustrated in FIG. 3B, either a front-facing camera of the client-computing device 202a is currently viewing the user of the client-computing device 202a (e.g., a “selfie).

In at least one embodiment, as described above, the media effect system 100 collects user information, device characteristics, and determines contextual information. For example, in response to collecting and analyzing information including the GPS coordinates of the client-computing device 202a, the camera orientation of the client-computing device 202a, and the contents of the viewfinder of the camera of the client-computing device 202a, the media effect system 100 can determine the contextual information that the user is about to capture a “selfie” at a sports game.

In one or more embodiments, the camera viewfinder display 312 includes a display of what a camera associated with the client-computing device 202a is currently viewing. Thus, as illustrated in FIG. 3B, either a front-facing camera of the client-computing device 202a is currently viewing the user of the client-computing device 202a (e.g., a “selfie”), or a rear-facing camera of the client-computing device 202a is currently viewing another person standing in front of the user of the client-computing device 202a. In alternative embodiments, the user can capture an image using the capture control 316c and the media effect system 100 applies the customized media effect to the captured image.

In still further embodiments, the user can navigate to previously stored images using camera roll control 316d. For example, in response to a selection of the camera roll control 316d, the media effect system 100 can present a camera roll along the bottom of the camera viewfinder display 312 including the most recent images captured on the client-computing device 202a. In at least one embodiment, the media effect system 100 can automatically apply various media effects to the images displayed in the camera roll. For example, if the camera roll includes additional images taken within a threshold amount of time from the current time or at the same location where the client-computing device 202a is currently located, the media effect system 100 can apply the same media effect elements 318a and 318b to the camera roll images.

Additionally or alternatively, the media effect system 100 can apply different media effects to images in the camera roll than the media effects applied to the camera viewfinder display 312. For example, as described above, the media effect system 100 may apply masks, textual overlays, and so forth to the camera viewfinder display 312. In one or more embodiments, the media effect system 100 may apply different media effects to images in a camera roll than those applied to the camera viewfinder display 312 such as media effects that change the color pallet of an image, media effects that change the lighting of an image, media effects that convert an image to black and white, etc.

Referring again to FIG. 3B, the media effect system 100 collects and analyzes user information regarding the user of the client-computing device 202a including the information related to the user's interactions with the client-computing device 202a as well as information associated with the user's interactions with one or more communications systems (e.g., a social networking system).

Additionally, the media effect system 100 utilizes the device characteristics and user information to identify contextual information. For example, in light of the location and current time, the media effects system 100 can determine that the client-computing device 202a is at Oracle Arena and the Warriors are playing the Thunder at a professional basketball game. The media effects system 100 can further identify that the user is a fan of the Warriors or has a high affinity score associated with the Warriors. The media effect system 100 can also perform facial recognition to identify a face of the user and a friend of the user Lisa Chen in the viewfinder. Based on the contextual information, the media effect system 100 generates a customized media effect.

For example, the media effect system 100 can determine, based on the contextual information, that a media effect overlay template with basketball icon media effect element 318a and a “Go [enter team field]!” textual overlay media effect element 318b has a high score. Based on the high score, the media effect system 100 select the media effect overlay template and enters determined contextual information into the fields of the media effect overlay template. For example, as shown in FIG. 3B, the media effect system 100 generates a customized media effect including media effect overlay template with basketball icon media effect element 318a, enters “Warriors” into the team field of the media effect element 318b. The media effect system 100 can also add a location tag and can add a tag of a detected person in the viewfinder.

One will appreciate that the media effect overlay template of FIG. 3B includes a single field (i.e., 318b) to be filed out by the media effect system 100 with contextual information. Alternative embodiments can include more fields such as the date, weather, event name, etc.

As shown by FIG. 3B, the media effect system 100 generates and provides the customized media effects 318a and 318b, along with other tags for locations and people, without requiring the user to manually provide any feedback other than opening the viewfinder. Thus, the media effect system 100 generates a robust customized media effect that provides details such as the location, name of friends in the picture, name of a team that the user likes, an overlay template relative to the event at which the user is attending without requiring the user to provide any of the foregoing information. The media effect system 100 generates the customized media effect and presents the customized media effect upon opening the viewfinder and allows the user to share, send, or post the customized media communication (i.e., the combination of the customized media effect and an underlying image/video) in seconds (or less). Thus, the user can share, send, or post a customized media communication in the moment in a matter of a couple of seconds rather than having to manually select a media effect and manually add contextual information to the media effect.

Furthermore, in at least one embodiment, the media effect system 100 can provide additional media effects in combination with the camera viewfinder display 312. As described herein, the media effect system 100 provides a customized media effect in combination with the camera viewfinder display 312 immediately upon presenting the camera viewfinder display 312. In at least one embodiment, the media effect system 100 displays additional customized media effects in combination with the camera viewfinder display 312 in response to receiving a predetermined user interaction. For example, in one embodiment, in response to receiving a swipe in connection with the camera viewfinder display 312, the media effect system 100 can replace the customized media effects 318a and 318b with additional customized media effects. The media effect system 100 can provide the additional customized media effects because the additional customized media effects are high scoring, are popular among the user demographic that includes the user of the client-computing device 202a, are promoted by a sponsor of the event the user of the client-computing device 202a is attending, and so forth. Alternatively, the media effect system 100 can layer the additional customized media effects on the customized media effects 318a and 318b in response to receiving a predetermined user interaction (e.g., a scroll).

Thus, the resulting customized media effect, as shown in FIG. 3B, adds variety and depth to an otherwise standard “selfie.” For example, a viewer of the media communication resulting from the combination of the “selfie” and the customized media effect, as previewed in the camera viewfinder display 312, would easily determine that the person depicted in the media communication is celebrating the performance of a favorite sports team. This fact may not have been made clear by only the unenhanced “selfie.”

In one or more embodiments, the media effect system 100 enables the user of the client-computing device 202a to layer additional media effects on top of one or more of the top-ranked media effects. For example, in response to detecting a selection of the media effect control 316a, the media effect system 100 can present media effect controls 336a, 336b, 336c, 336d as shown in FIG. 3C. In response to user input selecting an additional media effect using a media effect control (e.g., 336b), the media effect system 100 can add a selected media effect to the customized media effect. For example, FIG. 3D illustrates that the media effect system 100 has added sunglasses 318e to the customized media effect. As such, in addition to providing a customized media effect without user input, the media effect system 100 can also provide the user the ability edit, revise, or supplement the customized media effect.

In response to detecting a capture of a digital photograph or video (e.g., either in combination with a customized media effect or without), the media effect system 100 provides a post composition GUI 322 on the touch screen display 303 of the client-computing device 202a. As shown in FIG. 3E, the post composition GUI 322 includes a post composition option 326 that enables the user of the client-computing device 202a to input a post with the customized image shown in the camera viewfinder display 312, as described above.

Additionally, the post composition GUI 322 includes a list 324 of friends (e.g., co-users of the user of the client-computing device 202a) that includes tag controls 328a-328e that enables the user to select additional co-users to associated with the media communication and/or social networking system post. In additional embodiments, the post composition GUI 322 also includes a location control that enables the user to specify a location in connection with the media communication and/or social networking system post. Once the user is satisfied with the appearance of the post (e.g., including the customized image, the post text, the list of users with whom the post will be shared, etc.), the user may select the share button 330. In response to detecting the selection of the share button 330, the media effect system 100 can send the customized image together with the options specified within the post composition GUI 322 to one or more users of the communications system. For example, the user can share the customized image together with the additional options as a social networking system post and share the generated post with “friends” of the user of the client-computing device 202a. Alternatively, the communications client application 203a can send the media communication directly to one or more co-users specified by the user of the client computing device 202a as a direct message.

In another example, in response to detecting a selection of the camera icon 302, as shown in FIG. 3A, the media effect system 100 collects device characteristics, user information, and determines contextual information. For example, the media effect system 100 can determine that the location of the client-computing device 202a, the weather where the client-computing device 202a is located, the subject matter depicted in the camera viewfinder display 312. Based on this information, the media effect system 100 determines that the client-computing device 202a is located at Stanford University and that the weather is rainy and overcast. Based on this contextual information, the media effect system 100 can identify media effects compatible with the contextual information. The media effect system 100 can then score the compatible media effects and generate a customized media effect including one or more highly scored media effects.

Accordingly, immediately upon initialization of the application associated with the camera icon 302, the media effect system 100 generates a customized media effect including the media effects 318f, 318g, and 318h, as shown in FIG. 3E. For example, as shown in FIG. 3E, the media effect system 100 includes the media effect 318f (e.g., storm cloud graphic), the media effect 318g (e.g., the textual element “Rainy Days on Campus”), and the media effect 318h (e.g., animated rain drops falling from the top of the camera viewfinder display 312). Thus, rather than completing fields in a template media effect, the media effect system can score different media effects and use the scores to create dynamic, customized media effects based on the current environment of the client-computing device 202a.

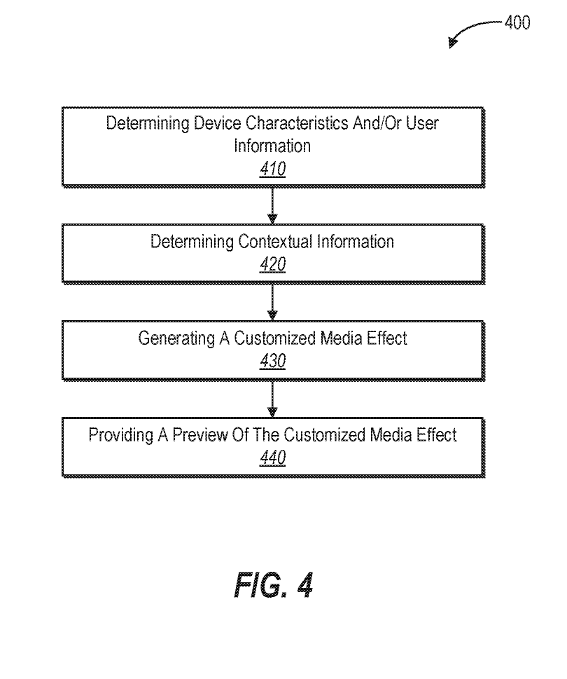

FIGS. 1-3F, the corresponding text, and the examples, provide a number of different methods, systems, and devices for generating customized media effects. In addition to the foregoing, one or more embodiments can also be described in terms of flowcharts comprising acts in a method for accomplishing a particular result. For example, FIG. 4 may be performed with less or more acts or the acts may be performed in differing orders. Additionally, the acts described herein may be repeated or performed in parallel with one another or in parallel with different instances of the same or similar acts.

FIG. 4 illustrates a flowchart of one example method 400 of generating a media customized media effect. The method 400 includes an act 410 of determining device characteristics and/or user information. For example, act 410 can involve determining one or more of device characteristics associated a client-computing device 202a or user information associated with a user of the client-computing device 202a. For instance, act 410 can involve determining a location of the client-computing device 202a, one or more likes or dislikes of the user that relates to the location, an orientation of the client-computing device 202a, a currently activated camera of the client-computing device 202a, etc.

Additionally, the method 400 includes an act 420 of determining contextual information. For example, act 420 can involve determining, based on the determined one or more of the device characteristics or the user information and without user input, contextual information. In particular, act 420 can involve identifying an event associated with a detected location of the client-computing device. Still further, act 420 can involve identifying a user relationship with a detected location of the client-computing device by querying a social graph. In additional embodiments, act 420 can involve determining one or more of an event occurring at a location of the client-computing device, a current condition of weather at the location of the client-computing device, previous activity of the user on a communications system while at the location of the client-computing device, a preexisting relationship between the user and the location of the client-computing device, a place of interest corresponding to the location of the client-computing device, or a subject of a calendar event of the user scheduled at the location of the client-computing device.

The method 400 also includes an act 430 of generating a customized media effect. In particular, the act 430 involves generating a customized media effect based on the contextual information. For example, act 430 can involve identifying a media effect template and filling in one or more fields of the media effect template with the contextual information. In such embodiments, identifying the media effect template can involve identifying one or more correlations between the contextual information and metadata associated with each of a plurality of media effect templates; scoring media effect templates of the plurality of media effect templates based on the identified one or more correlations; and selecting the media effect template based on the media effect template having a high score. Optionally, the media effect template comprises an overlay template.

In additional embodiments, act 430 can involve combining a set of media effects. For example, act 430 can involve identifying one or more correlations between the contextual information and metadata associated with each of a plurality of media effects; scoring media effects of the plurality of media effects based on the identified one or more correlations; and selecting the set of media effects based on the media effects in the set of media effects having high scores and being compatible with each other. In such embodiments, the set of media effects comprises one or more of filters, masks, overlays, animations, graphics, or frames.

Act 430 can also involve identifying a plurality of media effects compatible with the orientation of the client-computing device or the currently activated camera of the client-computing device. Furthermore, act 430 can involve scoring media effects of the plurality of media effects based on the contextual information; and selecting a set of media effects from the plurality of media effects based on the media effects in the set of media effects having high scores. In such instances, act 430 can involve combining the set of selected media effects to generate the customized media effect. Still further, act 430 can involve populating one or more fields with the contextual information.

The method 400 also includes an act 440 of providing a preview of the customized media effect. For example, act 440 can involve providing the customized media communication effect in combination with a live feed from a camera of the client-computing device. Still further act 440 can involve providing the preview of the customized media effect upon opening a viewfinder on the client-computing device.

The method 400 can also involve generating a customized media communication by combining the customized media communication effect with a captured image or video.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 5 illustrates a block diagram of exemplary computing device 500 that may be configured to perform one or more of the processes described above. One will appreciate that one or more computing devices such as the computing device 500 may implement the media effect system 100. As shown by FIG. 5, the computing device 500 can comprise a processor 502, a memory 504, a storage device 506, an I/O interface 508, and a communication interface 510, which may be communicatively coupled by way of a communication infrastructure 512. While an exemplary computing device 500 is shown in FIG. 5, the components illustrated in FIG. 5 are not intended to be limiting. Additional or alternative components may be used in other embodiments. Furthermore, in certain embodiments, the computing device 500 can include fewer components than those shown in FIG. 5. Components of the computing device 500 shown in FIG. 5 will now be described in additional detail.

In one or more embodiments, the processor 502 includes hardware for executing instructions, such as those making up a computer program. As an example and not by way of limitation, to execute instructions, the processor 502 may retrieve (or fetch) the instructions from an internal register, an internal cache, the memory 504, or the storage device 506 and decode and execute them. In one or more embodiments, the processor 502 may include one or more internal caches for data, instructions, or addresses. As an example and not by way of limitation, the processor 502 may include one or more instruction caches, one or more data caches, and one or more translation lookaside buffers (TLBs). Instructions in the instruction caches may be copies of instructions in the memory 504 or the storage device 506.

The memory 504 may be used for storing data, metadata, and programs for execution by the processor(s). The memory 504 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 504 may be internal or distributed memory.

The storage device 506 includes storage for storing data or instructions. As an example and not by way of limitation, storage device 506 can comprise a non-transitory storage medium described above. The storage device 506 may include a hard disk drive (HDD), a floppy disk drive, flash memory, an optical disc, a magneto-optical disc, magnetic tape, or a Universal Serial Bus (USB) drive or a combination of two or more of these. The storage device 506 may include removable or non-removable (or fixed) media, where appropriate. The storage device 506 may be internal or external to the computing device 500. In one or more embodiments, the storage device 506 is non-volatile, solid-state memory. In other embodiments, the storage device 506 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 508 allows a user to provide input to, receive output from, and otherwise transfer data to and receive data from computing device 500. The I/O interface 508 may include a mouse, a keypad or a keyboard, a touch screen, a camera, an optical scanner, network interface, modem, other known I/O devices or a combination of such I/O interfaces. The I/O interface 508 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 508 is configured to provide graphical data to a display for presentation to a user. The graphical data may be representative of one or more graphical user interfaces and/or any other graphical content as may serve a particular implementation.

The communication interface 510 can include hardware, software, or both. In any event, the communication interface 510 can provide one or more interfaces for communication (such as, for example, packet-based communication) between the computing device 500 and one or more other computing devices or networks. As an example and not by way of limitation, the communication interface 510 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 510 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 510 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 510 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 512 may include hardware, software, or both that couples components of the computing device 500 to each other. As an example and not by way of limitation, the communication infrastructure 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the media effect system 100 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., posts, photo-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example, and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similar to events, the calendar entries may include times, dates, locations and identities of other users.

FIG. 6 illustrates an example network environment 600 of a social networking system. Network environment 600 includes a client device 606, a social networking system 602, and a third-party system 608 connected to each other by a network 604. Although FIG. 6 illustrates a particular arrangement of client device 606, social networking system 602, third-party system 608, and network 604, this disclosure contemplates any suitable arrangement of client device 606, social networking system 602, third-party system 608, and network 604. As an example and not by way of limitation, two or more of client device 606, social networking system 602, and third-party system 608 may be connected to each other directly, bypassing network 604. As another example, two or more of client device 606, social networking system 602, and third-party system 608 may be physically or logically co-located with each other in whole or in part. Moreover, although FIG. 6 illustrates a particular number of client devices 606, social networking systems 602, third-party systems 608, and networks 604, this disclosure contemplates any suitable number of client devices 606, social networking systems 602, third-party systems 608, and networks 604. As an example and not by way of limitation, network environment 600 may include multiple client device 606, social networking systems 602, third-party systems 608, and networks 604.

This disclosure contemplates any suitable network 604. As an example and not by way of limitation, one or more portions of network 604 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 604 may include one or more networks 604.

Links may connect client device 606, social networking system 602, and third-party system 608 to communication network 604 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 600. One or more first links may differ in one or more respects from one or more second links.

In particular embodiments, client device 606 may be an electronic device including hardware, software, or embedded logic components or a combination of two or more such components and capable of carrying out the appropriate functionalities implemented or supported by client device 606. As an example and not by way of limitation, a client device 606 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 606. A client device 606 may enable a network user at client device 606 to access network 604. A client device 606 may enable its user to communicate with other users at other client devices 606.

In particular embodiments, client device 606 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 606 may enter a Uniform Resource Locator (URL) or other address directing the web browser to a particular server (such as server, or a server associated with a third-party system 608), and the web browser may generate a Hyper Text Transfer Protocol (HTTP) request and communicate the HTTP request to server. The server may accept the HTTP request and communicate to client device 606 one or more Hyper Text Markup Language (HTML) files responsive to the HTTP request. Client device 606 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 602 may be a network-addressable computing system that can host an online social network. Social networking system 602 may generate, store, receive, and send social-networking data, such as, for example, user-profile data, concept-profile data, social-graph information, or other suitable data related to the online social network. Social networking system 602 may be accessed by the other components of network environment 600 either directly or via network 604. In particular embodiments, social networking system 602 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 602 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 606, a social networking system 602, or a third-party system 608 to manage, retrieve, modify, add, or delete, the information stored in data store.

In particular embodiments, social networking system 602 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 602 may provide users of the online social network the ability to communicate and interact with other users. In particular embodiments, users may join the online social network via social networking system 602 and then add connections (e.g., relationships) to a number of other users of social networking system 602 whom they want to be connected to. Herein, the term “friend” may refer to any other user of social networking system 602 with whom a user has formed a connection, association, or relationship via social networking system 602.

In particular embodiments, social networking system 602 may provide users with the ability to take actions on various types of items or objects, supported by social networking system 602. As an example and not by way of limitation, the items and objects may include groups or social networks to which users of social networking system 602 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 602 or by an external system of third-party system 608, which is separate from social networking system 602 and coupled to social networking system 602 via a network 604.

In particular embodiments, social networking system 602 may be capable of linking a variety of entities. As an example and not by way of limitation, social networking system 602 may enable users to interact with each other as well as receive content from third-party systems 608 or other entities, or to allow users to interact with these entities through an application programming interfaces (API) or other communication channels.

In particular embodiments, a third-party system 608 may include one or more types of servers, one or more data stores, one or more interfaces, including but not limited to APIs, one or more web services, one or more content sources, one or more networks, or any other suitable components, e.g., that servers may communicate with. A third-party system 608 may be operated by a different entity from an entity operating social networking system 602. In particular embodiments, however, social networking system 602 and third-party systems 608 may operate in conjunction with each other to provide social-networking services to users of social networking system 602 or third-party systems 608. In this sense, social networking system 602 may provide a platform, or backbone, which other systems, such as third-party systems 608, may use to provide social-networking services and functionality to users across the Internet.

In particular embodiments, a third-party system 608 may include a third-party content object provider. A third-party content object provider may include one or more sources of content objects, which may be communicated to a client device 606. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 602 also includes user-generated content objects, which may enhance a user's interactions with social networking system 602. User-generated content may include anything a user can add, upload, send, or “post” to social networking system 602. As an example and not by way of limitation, a user communicates posts to social networking system 602 from a client device 606. Posts may include data such as status updates or other textual data, location information, photos, videos, links, music or other similar data or media. Content may also be added to social networking system 602 by a third-party through a “communication channel,” such as a newsfeed or stream.

In particular embodiments, social networking system 602 may include a variety of servers, sub-systems, programs, modules, logs, and data stores. In particular embodiments, social networking system 602 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 602 may also include suitable components such as network interfaces, security mechanisms, load balancers, failover servers, management-and-network-operations consoles, other suitable components, or any suitable combination thereof. In particular embodiments, social networking system 602 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 602 to one or more client devices 606 or one or more third-party system 608 via network 604. The web server may include a mail server or other messaging functionality for receiving and routing messages between social networking system 602 and one or more client devices 606. An API-request server may allow a third-party system 608 to access information from social networking system 602 by calling one or more APIs. An action logger may be used to receive communications from a web server about a user's actions on or off social networking system 602. In conjunction with the action log, a third-party-content-object log may be maintained of user exposures to third-party-content objects. A notification controller may provide information regarding content objects to a client device 606. Information may be pushed to a client device 606 as notifications, or information may be pulled from client device 606 responsive to a request received from client device 606. Authorization servers may be used to enforce one or more privacy settings of the users of social networking system 602. A privacy setting of a user determines how particular information associated with a user can be shared. The authorization server may allow users to opt in to or opt out of having their actions logged by social networking system 602 or shared with other systems (e.g., third-party system 608), such as, for example, by setting appropriate privacy settings. Third-party-content-object stores may be used to store content objects received from third parties, such as a third-party system 608. Location stores may be used for storing location information received from client devices 606 associated with users. Advertisement-pricing modules may combine social information, the current time, location information, or other suitable information to provide relevant advertisements, in the form of notifications, to a user.

FIG. 7 illustrates example social graph 700. In particular embodiments, social networking system 602 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social networking system 602, client device 606, or third-party system 608 may access social graph 700 and related social-graph information for suitable applications. The nodes and edges of social graph 700 may be stored as data objects, for example, in a data store (such as a social-graph database). Such a data store may include one or more searchable or query able indexes of nodes or edges of social graph 700.

In particular embodiments, a user node 702 may correspond to a user of social networking system 602. As an example and not by way of limitation, a user may be an individual (human user), an entity (e.g., an enterprise, business, or third-party application), or a group (e.g., of individuals or entities) that interacts or communicates with or over social networking system 602. In particular embodiments, when a user registers for an account with social networking system 602, social networking system 602 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social networking system 602. In particular embodiments, a user node 702 may be associated with information provided by a user or information gathered by various systems, including social networking system 602. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 602 or a third-party website associated with a web-application server); an entity (such as, for example, a person, business, group, sports team, or celebrity); a resource (such as, for example, an audio file, video file, digital photo, text file, structured document, or application) which may be located within social networking system 602 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 704 may be associated with information of a concept provided by a user or information gathered by various systems, including social networking system 602. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social networking system 602. Profile pages may also be hosted on third-party websites associated with a third-party system 608. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 608. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 606 to send to social networking system 602 a message indicating the user's action. In response to the message, social networking system 602 may create an edge (e.g., an “eat” edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social networking system 602 may send a “friend request” to the second user. If the second user confirms the “friend request,” social networking system 602 may create an edge 706 connecting the first user's user node 702 to the second user's user node 702 in social graph 700 and store edge 706 as social-graph information in one or more of data stores. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social networking system 602 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 602 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social networking system 602 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social networking system 602 may create an edge 706 between a user node 702 and a concept node 704 in social graph 700. As an example and not by way of limitation, a user viewing a concept-profile page (such as, for example, by using a web browser or a special-purpose application hosted by the user's client device 606) may indicate that he or she likes the concept represented by the concept node 704 by clicking or selecting a “Like” icon, which may cause the user's client device 606 to send to social networking system 602 a message indicating the user's liking of the concept associated with the concept-profile page. In response to the message, social networking system 602 may create an edge 706 between user node 702 associated with the user and concept node 704, as illustrated by “like” edge 706 between the user and concept node 704. In particular embodiments, social networking system 602 may store an edge 706 in one or more data stores. In particular embodiments, an edge 706 may be automatically formed by social networking system 602 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social networking system 602). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 602 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 602) or RSVP (e.g., through social networking system 602) to an event associated with the advertisement. In addition or as an alternative, an advertisement may include social-networking-system context directed to the user. As an example and not by way of limitation, an advertisement may display information about a friend of the user within social networking system 602 who has taken an action associated with the subject matter of the advertisement.

In particular embodiments, social networking system 602 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 608 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 602 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 602 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 602 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 602 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 602 may calculate a coefficient based on a user's actions. Social networking system 602 may monitor such actions on the online social network, on a third-party system 608, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 602 may calculate a coefficient based on the user's actions with particular types of content. The content may be associated with the online social network, a third-party system 608, or another suitable system. The content may include users, profile pages, posts, news stories, headlines, instant messages, chat room conversations, emails, advertisements, pictures, video, music, other suitable objects, or any combination thereof. Social networking system 602 may analyze a user's actions to determine whether one or more of the actions indicate an affinity for subject matter, content, other users, and so forth. As an example and not by way of limitation, if a user may make frequently posts content related to “coffee” or variants thereof, social networking system 602 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 602 may calculate a coefficient based on the type of relationship between particular objects. Referencing the social graph 700, social networking system 602 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than a user node 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 602 may determine that the user has a higher coefficient with respect to the first photo than the second photo because having a tagged-in-type relationship with content may be assigned a higher weight and/or rating than having a like-type relationship with content. In particular embodiments, social networking system 602 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 602 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social networking system 602 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 606 of the user). A first user may be more interested in other users or concepts that are closer to the first user. As an example and not by way of limitation, if a user is one mile from an airport and two miles from a gas station, social networking system 602 may determine that the user has a higher coefficient for the airport than the gas station based on the proximity of the airport to the user.

In particular embodiments, social networking system 602 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 602 may provide information that is relevant to user's interests and current circumstances, increasing the likelihood that they will find such information of interest. In particular embodiments, social networking system 602 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 602 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 602 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 608 (e.g., via an API or other communication channel), or from another suitable system. In response to the request, social networking system 602 may calculate the coefficient (or access the coefficient information if it has previously been calculated and stored). In particular embodiments, social networking system 602 may measure an affinity with respect to a particular process. Different processes (both internal and external to the online social network) may request a coefficient for a particular object or set of objects. Social networking system 602 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social networking system 602 or shared with other systems (e.g., third-party system 608). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 608, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 602 may send a request to the data store for the object. The request may identify the user associated with the request and may only be sent to the user (or a client device 606 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

1. A method comprising:
determining, by at least one processor, one or more of device characteristics associated a client-computing device or user information associated with a user of the client-computing device;
determining, based on the determined one or more of the device characteristics or the user information and without user input, contextual information;
generating, by the at least one processor, a customized media effect based on the contextual information by:
identifying a media effect template comprising at least one media effect and at least one field for inserting an additional media effect,
generating the additional media effect based on the contextual information, and
inserting the additional media effect into the at least one field; and
providing a preview of the customized media effect.

2. (canceled)

3. The method as recited in claim 1, wherein identifying the media effect template comprises:
identifying one or more correlations between the contextual information and metadata associated with each of a plurality of media effect templates;
scoring media effect templates of the plurality of media effect templates based on the identified one or more correlations; and
selecting the media effect template based on the media effect template having a high score.

4. The method as recited in claim 1, wherein the media effect template comprises an overlay template.

5. The method as recited in claim 1, wherein generating the additional media effect based on the contextual information comprises combining a set of media effects.

6. The method as recited in claim 5, further comprising:
identifying one or more correlations between the contextual information and metadata associated with each of a plurality of media effects;
scoring media effects of the plurality of media effects based on the identified one or more correlations; and
selecting the set of media effects based on the media effects in the set of media effects having high scores and being compatible with each other.

7. The method as recited in claim 5, wherein the set of media effects comprises one or more of filters, masks, overlays, animations, graphics, or frames.

8. The method as recited in claim 1, further comprising, in response to providing the preview of the customized media communication effect, generating a customized media communication by combining the customized media effect with a captured image or video.

9. The method as recited in claim 1, wherein determining, based on the determined one or more of the device characteristics or the user information and without user input, contextual information comprises identifying an event associated with a detected location of the client-computing device.

10. The method as recited in claim 1, wherein determining, based on the determined one or more of the device characteristics or the user information and without user input, contextual information comprises identifying a user relationship with a detected location of the client-computing device by querying a social graph.

11. The method of claim 1, wherein determining one or more of device characteristics associated the client-computing device or user information associated with the user of the client-computing device comprises determining a location of the client-computing device and one or more likes or dislikes of the user that relates to the location.

12. The method of claim 1, wherein providing the preview of the customized media communication effect comprises providing the customized media effect in combination with a live feed from a camera of the client-computing device.

13. A system comprising:
at least one processor; and
at least one non-transitory computer-readable storage medium storing instructions thereon that, when executed by the at least one processor, cause the system to:
determine one or more of device characteristics associated a client-computing device or user information associated with a user of the client-computing device;
determine, based on the determined one or more of the device characteristics or the user information and without user input, contextual information;
generate a customized media effect based on the contextual information by:
identifying a media effect template comprising at least one media effect and at least one field for inserting an additional media effect,
generating the additional media effect based on the contextual information, and
inserting the additional media effect into the at least one field; and
provide a preview of the customized media effect.

14. The system as recited in claim 13, wherein determining, based on the determined one or more of the device characteristics or the user information and without user input, contextual information comprises determining one or more of an event occurring at a location of the client-computing device, a current condition of weather at the location of the client-computing device, previous activity of the user on a communications system while at the location of the client-computing device, a preexisting relationship between the user and the location of the client-computing device, a place of interest corresponding to the location of the client-computing device, or a subject of a calendar event of the user scheduled at the location of the client-computing device.

15. The system as recited in claim 13, wherein determining one or more of device characteristics associated the client-computing device or the user information associated with the user of the client-computing device comprises determining an orientation of the client-computing device or determining a currently activated camera of the client-computing device.

16. The system as recited in claim 15, wherein generating the additional media effect comprises identifying a media effect compatible with the orientation of the client-computing device or the currently activated camera of the client-computing device.

17. The system as recited in claim 16, further storing instructions thereon that, when executed by the at least one processor, cause the system to:
score media effects of the plurality of media effects based on the contextual information; and
select a set of media effects from the plurality of media effects based on the media effects in the set of media effects having high scores;
wherein generating the additional media effect based on the contextual information comprises combining the set of selected media effects.

18. A non-transitory computer-readable medium storing instructions thereon that, when executed by at least one processor, cause a computer system to:
determine one or more of device characteristics associated a client-computing device or user information associated with a user of the client-computing device;
determine based on the determined one or more of the device characteristics or the user information and without user input, contextual information;
generate a customized media effect based on the contextual information by:
identifying a media effect template comprising at least one media effect and at least one field for inserting an additional media effect,
generating the additional media effect based on the contextual information, and
inserting the additional media effect into the at least one field; and
provide a preview of the customized media effect.

19. The non-transitory computer-readable medium as recited in claim 18, wherein the instructions, when executed by the at least one processor, cause the computer system to provide the preview of the customized media effect upon opening a viewfinder on the client-computing device.

20. The non-transitory computer-readable medium as recited in claim 19, wherein the instructions, when executed by the at least one processor, cause the computer system to generate the additional media effect based on an orientation of the client-computing device.

21. The non-transitory computer-readable medium as recited in claim 20, wherein the instructions, when executed by the at least one processor, cause the computer system to provide the preview of the customized media effect in combination with a live feed from a camera of the client-computing device.
